(19) United States
(12) Patent Application Publication
(10) Pub. No.: US 2025/0130742 A1
(43) Pub. Date: Apr. 24, 2025

(54) METHOD OF CONTROLLING INFORMATION PROCESSING APPARATUS THAT USES EXTENSION APPLICATION ASSOCIATED WITH PRINTER DRIVER, STORAGE MEDIUM, AND INFORMATION PROCESSING APPARATUS

(71) Applicant: CANON KABUSHIKI KAISHA, Tokyo (JP)

(72) Inventor: HIROMU SATO, Kanagawa (JP)

(21) Appl. No.: 18/917,209

(22) Filed: Oct. 16, 2024

(30) Foreign Application Priority Data
Oct. 19, 2023 (JP) 2023-180108

(51) Int. Cl. G06F 3/12

(52) U.S. Cl. CPC G06F 3/1207; G06F 3/1259; G06F 3/1287

(57) ABSTRACT

A method of controlling an information processing apparatus including a standard driver that can communicate with a plurality of printing apparatuses of different models provided by a plurality of vendors, by using the IPP, and an extension application that is associated with the standard driver and supports the standard driver. The extension application acquires first status information of a printing apparatus connected to the information processing apparatus by using a method different from communication using the IPP. The extension application displays a status information notification screen based on the first status information.

### BACKGROUND OF THE INVENTION

### Field of the Invention

The present invention relates to a method of controlling an information processing apparatus that uses an extension application associated with a printer driver, a storage medium, and an information processing apparatus.

### Description of the Related Art

There is known a technique of providing a print instruction to a printing apparatus connected to a host computer by using a printer driver installed in the host computer as software for controlling the printing apparatus. In this technique, an operating system (OS) as basic software is installed in the host computer, and the printer driver is configured according to the specifications defined by the OS and is called from the OS for operation. Specifically, for example, a printer driver which is specific to a model and meets the specification of the OS, is provided from a vendor (manufacturer) of the printing apparatus, and the printer driver acquires information on a state of the printing apparatus (hereinafter referred to as the “status information”) using the OS and displays the acquired information on a computer screen. With this, the vendor of the printing apparatus can provide means for to a user to confirm the status information.

Further, in recent years, a class driver (hereinafter also referred to as the “standard driver”) which can be used by a plurality of printing apparatuses provided by respective vendors, i.e. printing apparatuses of different models is standardly installed in Windows (registered trademark). The standard driver is included in the OS package and is easily made capable of being used when an arbitrary printing apparatus is connected to the host computer. Therefore, when Windows (registered trademark) is installed as the OS, the host computer is not required to install another printer driver specific to the model to provide a print instruction. For this reason, the standard driver has high convenience.

Further, the standard driver acquires status information from a printing apparatus connected to a host computer by using a standard communication protocol. Specifically, the standard driver in the host computer acquires the status information, for example, by communicating with the printing apparatus according to communication standards of the Internet Printing Protocol (IPP). With this, the user using the standard driver can confirm the status information related to the capabilities of the printing apparatus connected to the host computer, in spite of using a single standard driver.

Further, an application for extending functions (hereinafter referred to as the “extension application”) can be associated with the standard driver. The extension application can be provided by the vendor of a printing apparatus. By providing the extension application, the vendor of the printing apparatus makes it possible to provide a function (i.e. the extended function) which cannot be realized by the standard driver alone. Japanese Laid-Open Patent Publication (Kokai) No. 2020-4159 discloses a method of using a function specific to a model by acquiring information concerning the function specific to the model, using a general-purpose driver. Further, Japanese Laid-Open Patent Publication (Kokai) No. 2017-68659 discloses a method of providing a monitor program that switchingly acquires the status information of the printing apparatus on a communication protocol basis to display the acquired status information on a terminal screen.

Incidentally, a printer driver specific to a model, which is provided by the vendor of the printing apparatus, can use a communication protocol (hereinafter referred to as the “vendor protocol”) uniquely defined by the vendor of the printing apparatus. The printer driver specific to the model can also acquire status information concerning the functions unique to the vendor or specific to the model by using the vendor protocol, and hence it is possible to provide a detailed guidance with respect to the state of the printing apparatus.

On the other hand, the standard driver which can be used regardless of the models of the printing apparatus uses the IPP as common communication standards, and hence, there is a case where it is impossible to acquire the status information concerning the functions unique to the vendor or specific to the model, and provide a detailed guidance with respect to the state of the printing apparatus. Further, depending on a type of the standard driver and a type of the communication interface, the extension application provided by the vendor of the printing apparatus can use the vendor protocol in one case or cannot use the vendor protocol in the other case. However, the extension application is configured to extend the functions of the standard driver, and hence the extension application is required to provide a function of enabling a user to accurately confirm the status information even when the vendor protocol cannot be used.

### SUMMARY OF THE INVENTION

The present invention provides a method of controlling an information processing apparatus that is capable of displaying a state of a printing apparatus in detail by using an extension application associated with a printer driver which can communicate with any printing apparatuses of different models, a storage medium, and an information processing apparatus.

In a first aspect of the present invention, there is provided a method of controlling an information processing apparatus including a standard driver that can communicate with a plurality of printing apparatuses provided by a plurality of vendors, by using a first protocol, and an application that is associated with the standard driver and supports the standard driver, including acquiring, by the application, first status information of a printing apparatus connected to the information processing apparatus, by using a method different from communication using the first protocol, and displaying, by the application, a status information notification screen based on the first status information.

In a second aspect of the present invention, there is provided an information processing apparatus including a standard driver that can communicate with a plurality of printing apparatuses provided by a plurality of vendors, by using a first protocol, and an application that is associated with the standard driver and supports the standard driver, including a first acquisition unit configured to acquire, by the application, first status information of a printing apparatus connected to the information processing apparatus, by using a method different from communication using the first protocol, and a display control unit configured to display, by the application, a status information notification screen based on the first status information.

According to the present invention, it is possible to display a state of a printing apparatus in detail by using the extension application associated with the printer driver which can communicate with any printing apparatuses of different models.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a printing system.

FIGS. 2A and 2B are block diagrams useful in explaining a software configuration of the printing system in a first embodiment.

FIG. 3 is a flowchart of a status information notification screen-displaying process.

FIG. 4 is a flowchart of a connection form identification process.

FIG. 5 is a flowchart of a status information acquisition method determination process.

FIG. 6 is a flowchart of a status information-complementing process in the first embodiment.

FIG. 7 is a diagram showing an example of a detailed guidance which can be displayed on a display section by a notification unit, as an example of a status information notification screen displayed in a case where a communication protocol is a vendor protocol, in the first embodiment.

FIG. 8 is a diagram showing an example of a guidance which can be displayed on the display section by the notification unit, as an example of the status information notification screen displayed in a case where the communication protocol is the IPP and the status information-complementing process is not performed.

FIG. 9 is a diagram showing an example of display provided when the notification unit displays a list of candidates of an error recovery method for recovering from a paper jam error on the display section, in the status information-complementing process, in the first embodiment.

FIG. 10 is a diagram showing an example of a detailed guidance which can be displayed on the display section by the notification unit, which is an example of the status information notification screen displayed in a case where the communication protocol is the IPP and the status information-complementing process is performed, in the first embodiment.

FIG. 11 is a block diagram useful in explaining a software configuration of the printing system in second and third embodiments.

FIG. 12 is a flowchart of a status information-complementing process in the second embodiment.

FIG. 13 is a diagram showing an example of a detailed guidance which can be displayed on the display section by the notification unit, which is an example of the status information notification screen displayed in a case where the communication protocol is the vendor protocol, in the second embodiment.

FIG. 14 is a diagram showing an example of a guidance which can be displayed on the display section by the notification unit, which is an example of the status information notification screen displayed in a case where the communication protocol is the IPP and the status information-complementing process is not performed.

FIG. 15 is a diagram showing an example of a detailed guidance which can be displayed on the display section by the notification unit, which is an example of the status information notification screen displayed in a case where the communication protocol is the IPP and the status information-complementing process is performed, in the second embodiment.

FIG. 16 is a flowchart of a status information-complementing process in the third embodiment.

FIG. 17 is a diagram showing an example of a guidance which can be displayed on the display section by the notification unit, which is an example of the status information notification screen displayed in a case where the communication protocol is the IPP and the status information-complementing process is not performed.

FIG. 18 is a diagram showing an example of a proper guidance which can be displayed on the display section by the notification unit, which is an example of the status information notification screen displayed in a case where the communication protocol is the IPP and the status information-complementing process is performed, in the third embodiment.

### DESCRIPTION OF THE EMBODIMENTS

The present invention will now be described in detail below with reference to the accompanying drawings showing embodiments thereof. The following description of the configuration of the embodiments is given by way of example, and the scope of the present invention is not limited to the described configuration of the embodiment. For example, components forming the present invention can be replaced by desired components which can exhibit the same functions, respectively. Further, a desired component can be added. Further, two or more desired components (features) of the embodiments can be combined.

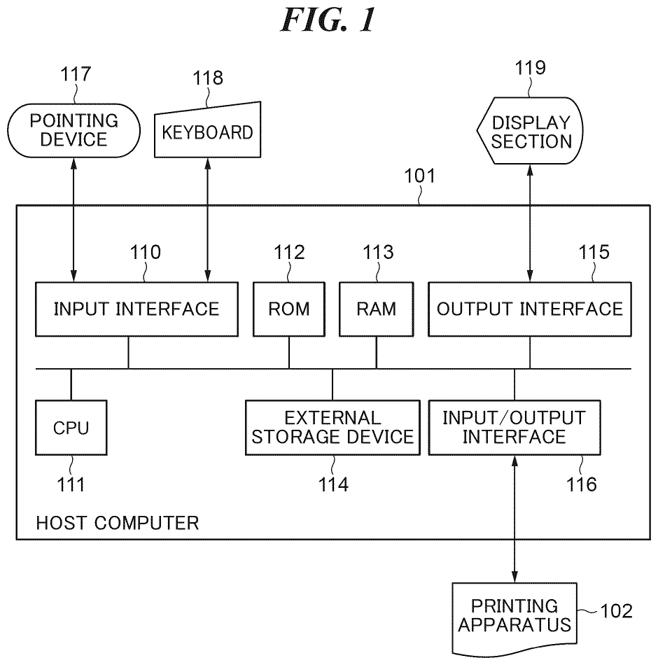

A first embodiment will be described below with reference to FIGS. 1 to 10.

FIG. 1 is a block diagram showing a hardware configuration of a printing system. As shown in FIG. 1, the printing system includes a host computer 101, a printing apparatus 102, and so forth. The host computer 101 is an example of an information processing apparatus and includes an input interface 110, a CPU 111, a ROM 112, a RAM 113, an external storage device 114, an output interface 115, and an input/output interface 116. Further, input devices, such as a pointing device 117 and a keyboard 118, are connected to the input interface 110, and a display device, such as a display section 119, is connected to the output interface 115. The ROM 112 stores an initialization program and the like.

The external storage device 114 stores an application program group, an operating system (OS), a standard driver, other programs, and a variety of data items. The RAM 113 is used, for example, as a work memory when executing a variety of programs stored in the external storage device 114, whereby the variety of programs are made operable in the host computer 101. Note that in the first embodiment, the CPU 111 executes functions of the host computer 101, described hereinafter, and processes described hereinafter with reference to figures showing respective flowcharts, by performing processing operations of the programs stored in the ROM 112. The printing apparatus 102 is connected to the host computer 101 via the input/output interface 116.

Here, although the host computer 101 and the printing apparatus 102 are configured as separate apparatuses, these can be configured as one information processing apparatus. Further, the printing apparatus 102 can have another function (such as a scanner) using the IPP as a communication protocol. Note that the IPP refers to the Internet Printing Protocol as the common communication specification, as mentioned above. Further, the host computer 101 can be a desktop-type personal computer, a smartphone, or a laptop-type personal computer.

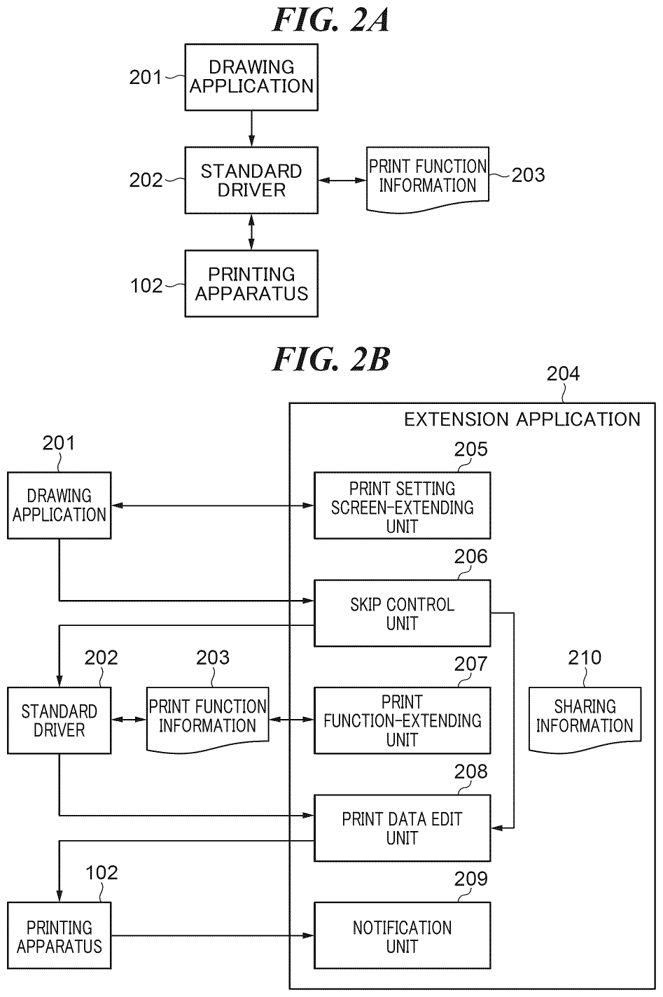

FIGS. 2A and 2B are block diagrams useful in explaining a software configuration of the printing system. Here, the description will be given assuming that the printing system uses the host computer 101 in which Windows (registered trademark) 11 of Microsoft (registered trademark) is installed as the OS. Referring to FIG. 2A, the host computer 101 includes a drawing application 201, a standard driver 202 (printer driver), and print function information 203, as components of the software of the host computer 101. Note that FIG. 2A is a diagram showing components of the software of a general printing system in a case where an extension application 204 appearing in FIG. 2B is not associated with the standard driver 202 and the printing apparatus 102. Note that the extension application 204 is an application provided from the vendor of the printing apparatus 102 as described above.

The drawing application 201 is software for generating contents (drawing data) to be printed. For example, a document generation application and a spreadsheet application correspond to the drawing application 201. Upon receipt of a print request from a user, the drawing application 201 issues a print instruction to the OS. The print instruction includes print settings information for instructing operations of the standard driver 202 and the printing apparatus 102. The print settings information is also referred to as the Print Ticket. The drawing application 201 can display a print setting screen provided by one of the standard driver 202, the OS, and the drawing application 201, so as to output the print settings information.

The print setting screen includes setting items indicating print functions which can be set and control items indicating settings of the setting items, which are set according to capabilities information (information which can be set as the print settings) acquired from the standard driver 202. The capabilities information is also referred to as the Print Capabilities (hereinafter referred to as the “PC”). The standard driver 202 determines the PC based on the print function information 203. The print function information 203 is data describing all print functions which can be set, settings thereof, and an exclusive relationship between the settings. The print function information 203 is also referred to as the Print Device Capabilities (PDC). The print function information 203 is included in a configuration file of the standard driver 202 and is disposed in the external storage device 114 as an unchangeable file. Alternatively, the print function information 203 can also be dynamically generated by the standard driver 202 or the OS.

Specifically, the standard driver 202 or the OS can be configured to acquire attribute data of the printing apparatus from the printing apparatus 102 and generate the print function information 203 according to attribute information in the acquired attribute data of the printing apparatus. In a case where the print function information 203 is dynamically generated, the generated print function information 203 is editable. Note that the attribute data of the printing apparatus, which is acquired from the printing apparatus 102, refers to a response acquired by issuing a Get-Printer-Attributes operation of the IPP to the printing apparatus 102. The response includes the attribute information indicating functions (capabilities of the printing apparatus 102) which can be designated in the printing apparatus 102 and settings related to the attribute information. The response is stored in the RAM 113.

With this configuration, the standard driver 202 enables, according to a printing apparatus connected to the host computer 101, a user to designate a print function which is available (capable of being used) in the connected printing apparatus. That is, even in a case where a printing apparatus having a different function or a printing apparatus provided by a different vendor is connected to the host computer 101, the standard driver 202 enables a user to designate an available print function according to the connected printing apparatus. Note that, here, a configuration using the IPP Class Driver standardly installed in Windows (registered trademark) 11 as the standard driver 202 will be described.

The IPP Class Driver is a printer driver that executes print processing according to the specifications of a standard print protocol, referred to as the IPP (first protocol), and is included in the OS package. The IPP Class Driver is not a printer driver specific to a model of the printing apparatus 102 but is a printer driver which can be commonly used for printing apparatuses provided by a plurality of vendors, respectively, i.e. printing apparatuses of different models. To enable a user to designate a print function supported by the printing apparatus 102 connected to the host computer 101, the IPP Class Driver acquires the capabilities information of the connected printing apparatus 102 and generates the print function information 203 based on the acquired capabilities information.

The OS generates intermediate data based on the print instruction output from the drawing application 201 and passes the generated intermediate data to the standard driver 202. Note that the data output for printing from the drawing application 201 is data of the Graphic Device Interface (GDI) format (GDI data) or data of the Extensible Markup Language (XML) Paper Specification format (XPS data). In a case where the IPP Class Driver is used as the standard driver 202, if the data output from the drawing application 201 is the GDI data, the OS converts the GDI data output from the drawing application 201 to XPS data. Then, the OS passes the converted XPS data to the standard driver 202 as the intermediate data.

On the other hand, if the data output from the drawing application 201 is the XPS data, the OS passes the XPS data to the standard driver 202 as the intermediate data. Note that the intermediate data includes drawing data as information on a picture to be formed on a sheet surface and the print settings information set by a user. The standard driver 202 converts the received intermediate data to print data which can be interpreted by the printing apparatus 102 and transmits the print data to the printing apparatus 102. Note that the print data includes the drawing data as the information on a picture to be formed on a sheet surface and print setting attribute information (attribute information for specifying print settings) generated based on the print settings information set by the user. The print setting attribute information includes attribute information indicating the functions which can be designated in the printing apparatus 102 (capabilities of the printing apparatus 102) and settings related to the attribute information.

The printing apparatus 102 performs printing on a sheet surface based on the print data transmitted from the standard driver 202. At this time, the printing apparatus 102 forms the drawing data included in the print data on the sheet surface, by performing the operation according to the print setting attribute information included in the print data. The print setting attribute information includes information on print quality (such as image quality priority or speed priority), a size of drawing data, and a drawing position (margin).

FIG. 2B is a diagram showing a software configuration of the printing system in a case where the extension application 204 is associated with the standard driver 202 and the printing apparatus 102. Note that components which are not particularly mentioned in the following description are the same as those appearing in FIG. 2A. The extension application 204 is software for extending the functions of the standard driver 202 and is not included (packaged) in the OS in advance. Therefore, the user is required to operate the host computer 101 to download the extension application 204 from a server on the Internet and install the same in the host computer 101. Alternatively, the extension application 204 can be automatically installed in the host computer 101 when the printing apparatus 102 is connected to the host computer 101.

In this case, when the printing apparatus 102 is connected to the host computer 101, the OS acquires device identification information from the printing apparatus 102. The OS downloads the extension application 204 associated with the acquired device identification information from the server on the Internet and installs the downloaded extension application 204 in the host computer 101. That is, the standard driver 202 and the extension application 204 are stored in the host computer 101 as different files. Note that although the standard driver 202 and the extension application 204 are each sometimes updated to an upgraded version, this update processing is performed at different timings. That is, in the host computer 101, the timing in which the standard driver 202 is updated and the timing in which the extension application 204 is updated are different. Further, in the host computer 101, a trigger for updating the standard driver 202 and a trigger for updating the extension application 204 are also different. Note that in a case where the extension application 204 is installed, the OS associates the extension application 204 with the standard driver 202 and the printing apparatus 102.

The extension application 204 described in the first embodiment includes a print setting screen-extending unit 205, a skip control unit 206, a print function-extending unit 207, a print data edit unit 208, and a notification unit 209. Further, the extension application 204 has sharing information 210 which can be commonly accessed from the units 205 to 209. In actuality, the sharing information 210 is a file stored in the external storage device 114 or information stored in the RAM 113. The extension application 204 writes information into the sharing information 210 and reads the information from the sharing information 210 by using an Application Program Interface (API) provided by the OS.

Note that the extension application 204 can terminate the operation whenever the processing performed by each of the units 205 to 209 is terminated. In this case, the OS starts the extension application 204 whenever a request for using any of the units 205 to 209 is received. Further, another form can be considered. For example, the OS terminates the operation of the extension application 204 when the processing performed by the print setting screen-extending unit 205 is terminated, but can continue activation of the extension application 204 even after the processing performed by the skip control unit 206 is terminated. Further, the extension application 204 can cancel the processing in the middle of the processing performed by each of the units 205 to 209. In a case where the extension application 204 cancels the processing, a job on a print queue, being processed, is deleted by the OS.

Upon receipt of a print request from a user, the drawing application 201 issues a print instruction to the OS. Similar to the configuration shown in FIG. 2A, under the configuration shown in FIG. 2B as well, the drawing application 201 can also display the print setting screen. However, under this configuration, a print setting screen provided by the extension application 204 is displayed. Specifically, the print setting screen-extending unit 205 of the extension application 204 provides a print setting screen by for display. Note that whether or not the print setting screen provided by the print setting screen-extending unit 205 is displayed depends on a user's operation. Further, when the drawing application 201 receives a print request from a user, and a print instruction is issued to the OS, the OS starts the skip control unit 206.

The skip control unit 206 performs skip control processing for controlling whether or not to skip conversion processing performed by the standard driver 202. After the skip control processing is executed by the skip control unit 206, the OS generates intermediate data based on the print instruction output from the drawing application 201 and passes the generated intermediate data to the standard driver 202. Here, in a case where the conversion processing performed by the standard driver 202 is not skipped, the intermediate data is converted by the standard driver 202 to print data which can be interpreted by the printing apparatus 102, and the print data is passed to the print data edit unit 208.

On the other hand, in a case where the conversion processing performed by the standard driver 202 is skipped, the intermediate data is passed to the print data edit unit 208 without being converted to print data by the standard driver 202. With this, the intermediate data can be processed by the print data edit unit 208. The print data edit unit 208 edits the intermediate data passed from the standard driver 202 or the print data processed by the standard driver 202. As details of editing, assuming that layout printing is performed by way of example, the print data edit unit 208 changes the layout of the intermediate data or the print data based on print settings information for layout printing, which is received from the OS.

Further, the print data edit unit 208 can display a user interface (UI) screen on the display section 119 and can display a result of the layout of the intermediate data or the print data, as a preview screen. Note that the print data edit unit 208 does not transmit the print data to the printing apparatus 102 in a state in which the preview screen remains open, but closing of the preview screen starts operation of processing for transmitting the print data. After the print data edit unit 208 has edited the print data, the print data is passed to the printing apparatus 102. The printing apparatus 102 performs printing on a sheet surface based on the received print data. Note that in a case where the conversion processing performed by the standard driver 202 is skipped, the print data edit unit 208 converts the received intermediate data to print data which can be interpreted by the printing apparatus 102. However, the intermediate data can be converted to print data by using a function provided by the OS.

The extension application 204 has the print function-extending unit 207. The print function-extending unit 207 can edit the print function information (PDC) 203 generated by the standard driver 202 or the OS. With this, the print function-extending unit 207 can add a function provided by the extension application 204 and one of the functions supported by the printing apparatus 102, which is not supported by the standard driver 202. Further, the print function-extending unit 207 can add an exclusive relationship between settings of the print function, and so forth. The OS starts the print function-extending unit 207 when the extension application 204 is associated with the standard driver 202 and the printing apparatus 102 for the first time. Further, the OS can start the print function-extending unit 207 at a timing, such as a timing in which the OS is started, other than the above-mentioned timing. With this, in a case where an optional device (such as a finisher) is added to the printing apparatus 102 later, whereby a function associated with printing is extended, the print function-extending unit 207 can detect the extended function and add the detected function to the print function information 203.

Further, the extension application 204 has the notification unit 209. The notification unit 209 displays a notification to a user, in response to occurrence of an error in the printing apparatus 102 or the like. For example, if a no-sheet error has occurred in the printing apparatus 102, the standard driver 202 detects occurrence of the no-sheet error and displays a message on the display section 119 by using a notification function referred to as the toast notification which is a function of the OS. When the user performs selection operation for the toast notification by using the pointing device 117 or the like, the notification unit 209 of the extension application 204 is called by the OS, and a UI screen of the notification unit 209 is displayed on the display section 119.

On the UI screen of the notification unit 209, a detailed message of the no-sheet error, a sheet supplying method, and so forth are displayed, for example. However, the notification unit 209 can display a notification to a user in other cases than the occurrence of an error in the printing apparatus 102. Note that once the print data is transmitted to the printing apparatus 102, the extension application 204 cannot display a screen, such as a guide associated with the print data, in the middle of the processing performed by each of the units 205 to 209. Further, the configuration of the extension application 204 for realizing the first embodiment is not limited to the configuration including all of the above-described functions (units) but can include only some of the functions or can include another function. That is, it can be said that the extension application 204 is an application including at least one of the functions of the units 205 to 209. Further, the extension application 204 is sometimes simply referred to as the print software.

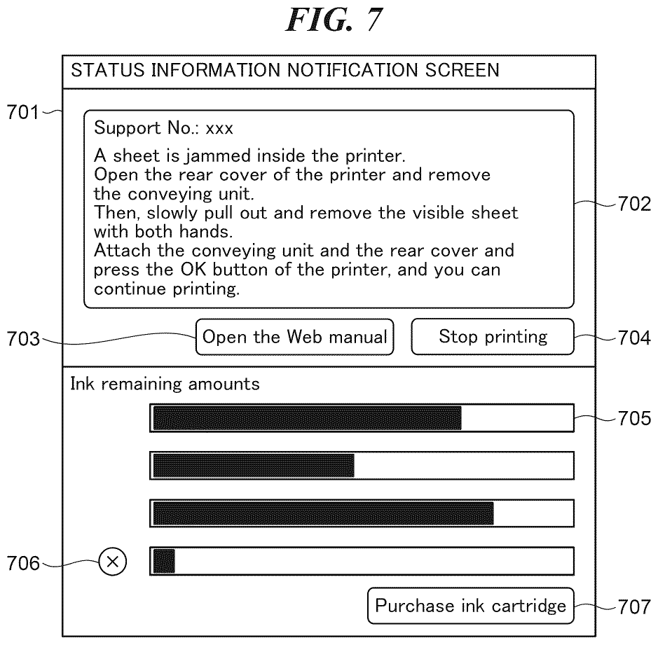

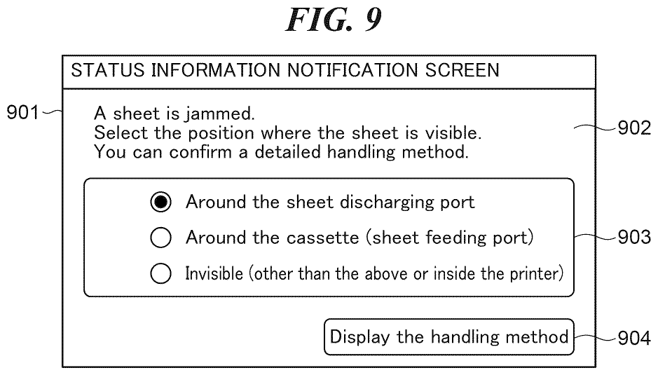

Note that, as described above, the function of the print setting screen-extending unit 205 is the function of displaying the setting screen. The function of the skip control unit 206 is the function of controlling whether or not to skip the conversion processing performed by the standard driver 202. The function of the print data edit unit 208 is the function of editing print data to be input to the printing apparatus 102. The function of the print function-extending unit 207 is the function of extending a function of the standard driver 202, which can be designated. The function of the notification unit 209 is the function of displaying a UI screen, in response to occurrence of an error in the printing apparatus 102 or the like. The UI screens displayed on the display section 119 by the notification unit 209 include status information notification screens 701 described hereinafter with reference to FIGS. 7, 8, 10, 13, 14, 15, 17, and 18, respectively, and a candidate list screen 901 described hereinafter with reference to FIG. 9.

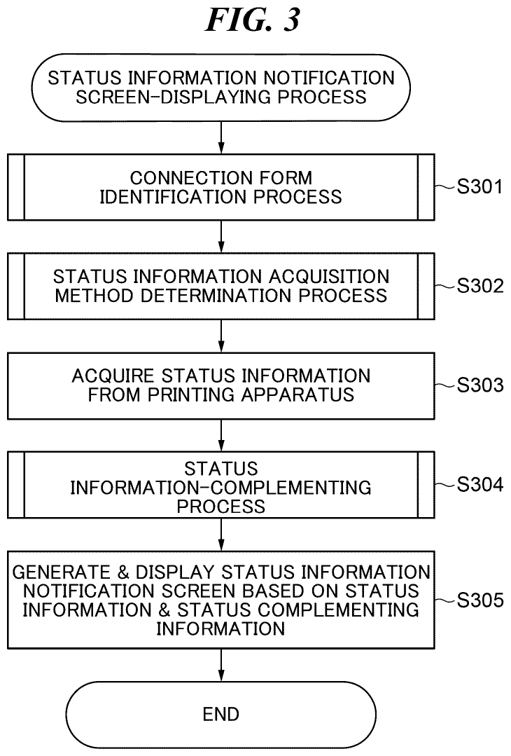

When a user makes a print request with respect to a print queue associated with the extension application 204 from the drawing application 201, the print processing is started by the printing apparatus 102. At this time, for example, if an error has occurred inside the printing apparatus 102, the OS displays a toast notification to the effect that an error has occurred on the display section 119. When the user performs selection operation on this toast notification by using the pointing device 117 or the like, the notification unit 209 of the extension application 204 is called by the OS. FIG. 3 is a flowchart of a status information notification screen-displaying process performed when the notification unit 209 (first acquisition unit) (display control unit) of the extension application 204 is called by the OS.

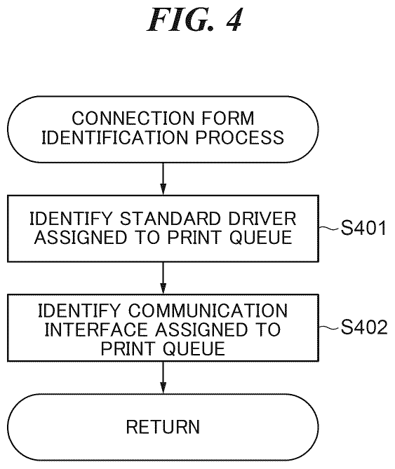

Note that the status information notification screen-displaying process is executed by the CPU 111 (computer) that loads a program stored in the ROM 112 into the RAM 113. Processes in FIGS. 4, 5, 6, 12, and 16, described hereinafter, are executed in the same fashion. When the status information notification screen-displaying process is started, first, in a step S301, the notification unit 209 of the extension application 204 performs a connection form identification process. In the connection form identification process, a form of connection between the printing apparatus 102 and the input/output interface 116 of the host computer 101 in the print queue to which the user has sent the print request is identified. Note that details of the step S301 will be described hereinafter with reference to FIG. 4.

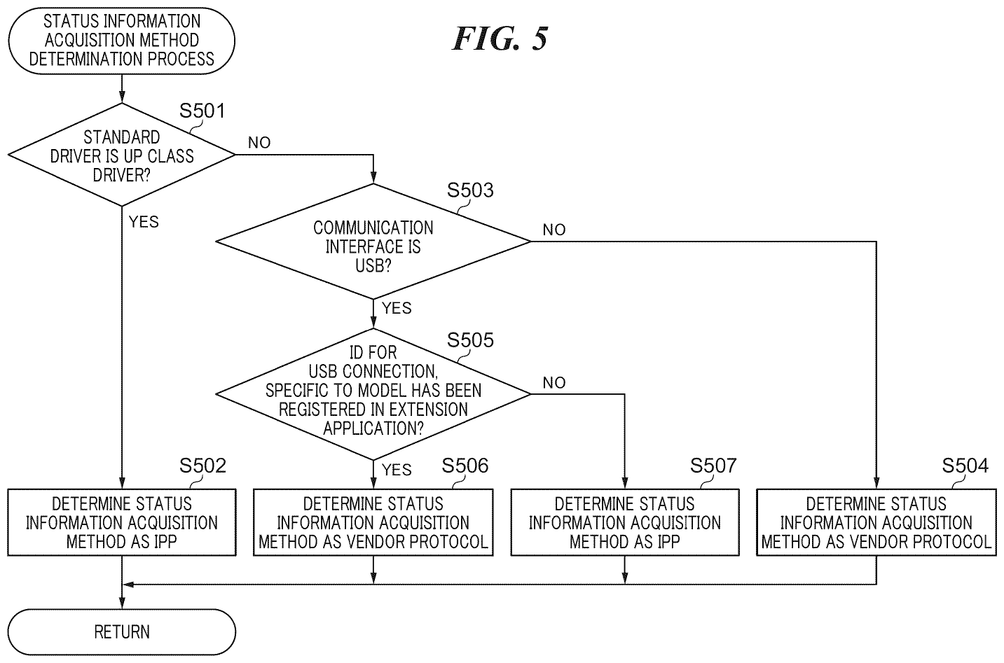

In a step S302, the notification unit 209 performs a status information acquisition method determination process. In the status information acquisition method determination process, a communication protocol used in communication with the printing apparatus 102 is determined according to the form of connection identified in the step S301. Note that details of the step S302 will be described hereinafter with reference to FIG. 5. The notification unit 209 can be configured not to execute the steps S301 and S302 whenever the status information is acquired but to store a result of execution after once executing the steps S301 and S302 and refer to the stored execution result after that.

In a step S303, the notification unit 209 communicates with the printing apparatus 102 by the communication protocol determined in the step S302 and acquires the status information (second status information) from the printing apparatus 102. Specifically, in a case where the communication protocol determined in the step S302 is the vendor protocol, the notification unit 209 acquires the status information of the printing apparatus 102 by communication using the vendor protocol. Note that, as described above, the vendor protocol refers to a communication protocol uniquely specified by the vendor of the printing apparatus 102. On the other hand, in a case where the communication protocol determined in the step S302 is the IPP, i.e. in a case where the extension application 204 cannot perform communication by the vendor protocol, the notification unit 209 acquires the status information of the printing apparatus 102 by communication using the IPP. Note that the status information of the printing apparatus 102, which is acquired by communication using the vendor protocol, is more detailed information than the status information of the printing apparatus 102, which is acquired by communication using the IPP, because the status information concerning a function unique to the vendor or specific to the model is included as described above.

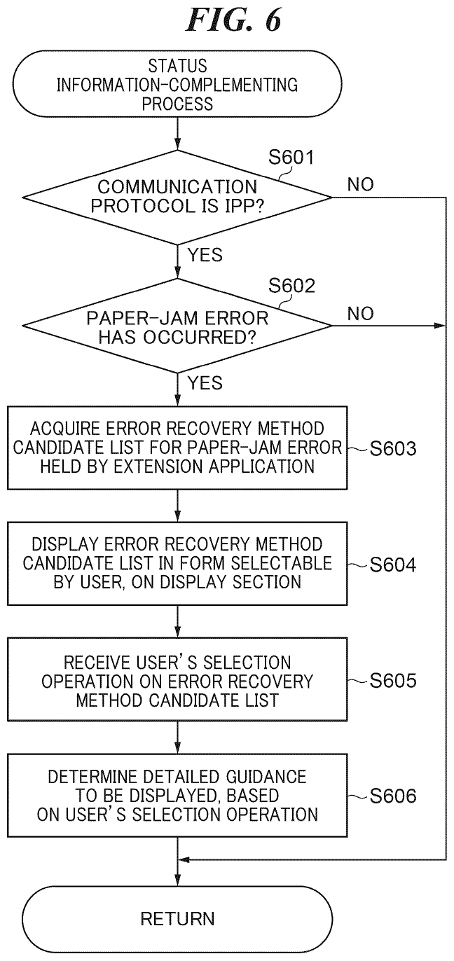

In a step S304, the notification unit 209 performs a status information-complementing process. Details of the step S304 will be described hereinafter with reference to FIG. 6. Note that in this process, in a case where the communication protocol determined in the step S302 is the IPP, information which cannot be acquired by communication using the IPP is acquired as status complementing information (first status information). That is, in a case where the extension application 204 cannot perform communication using the vendor protocol, the detailed status information equivalent to the status information acquired by communication using the vendor protocol is acquired by using a method different from communication using the IPP. Thus, the notification unit 209 compensates for unavailability of communication using the vendor protocol, i.e. impossibility of acquisition of the detailed status information. In a step S305, the notification unit 209 generates the status information notification screen as a guidance screen of the printing apparatus 102 based on the acquired status information and status complementing information and displays the generated status information notification screen on the display section 119. After that, the status information notification screen-displaying process is terminated.

FIG. 4 is a flowchart of the connection form identification process performed by the notification unit 209 in the step S301. In the connection form identification process, first, in a step S401, the notification unit 209 identifies a type of the standard driver 202 assigned to the print queue. The types of the standard driver 202 of which functions can be extended by the extension application 204 include not only the above-mentioned IPP Class Driver (second printer driver), but also Universal Print (UP) Class Driver (first printer driver). The notification unit 209 can perform identification in the step S401 based on the name of the standard driver 202. Note that the UP Class Driver is a printer driver standardly installed in Windows (registered trademark) 11 to perform printing by using a cloud service provided by Microsoft (registered trademark).

In a step S402, the notification unit 209 identifies a type of the communication interface (communication port) assigned to the print queue. After that, the connection form identification process is terminated, and the process returns to the status information notification screen-displaying process in FIG. 3. Note that the types of the communication interface include a USB port (hereinafter referred to as the “USB”), a WSD port (hereinafter referred to as the “WSD”), a TCP/IP port (hereinafter referred to as the “TCP/IP”), and so forth. The USB is an initialism of Universal Serial Bus. The WSD is an initialism of Web Service for Device. The TCP/IP is an initialism of Transmission Control Protocol/Internet Protocol.

FIG. 5 is a flowchart of the status information acquisition method determination process performed by the notification unit 209 in the step S302. The status information acquisition method determination process determines, based on the type of the standard driver 202 and the type of the communication interface, which are identified in the steps S401 and S402, respectively, whether or not the vendor protocol (second protocol) can be used. In the status information acquisition method determination process, first, in a step S501, the notification unit 209 determines whether or not the type of the standard driver 202, which is identified in the step S401, is the UP Class Driver. If it is determined by the notification unit 209 that the type of the standard driver 202, which is identified in the step S401, is the UP Class Driver, the process proceeds to a step S502. On the other hand, if it is determined by the notification unit 209 that the type of the standard driver 202, which is identified in the step S401, is not the UP Class Driver, the process proceeds to a step S503.

In the step S502, the notification unit 209 determines the status information acquisition method as the “IPP (vendor protocol cannot be used)” regardless of the type of the communication interface, which is identified in the step S402. This is because in a case where the type of the standard driver 202 is UP Class Driver, the extension application 204 cannot directly communicate with the printing apparatus 102 using the vendor protocol to acquire the status information. After that, the status information acquisition method determination process is terminated, and the process returns to the status information notification screen-displaying process in FIG. 3. Not that in this case, the extension application 204 performs communication with the printing apparatus 102 via a cloud service which is not provided by the vendor of the printing apparatus 102 (i.e. a cloud service provided by Microsoft (registered trademark)).

In the step S503, the notification unit 209 determines whether or not the type of the communication interface, which is identified in the step S402, is the USB (predetermined communication interface). If it is determined by the notification unit 209 that the type of the communication interface, which is identified in the step S402, is not the USB, the process proceeds to a step S504. On the other hand, if it is determined by the notification unit 209 that the type of the communication interface, which is identified in the step S402, is the USB, the process proceeds to a step S505. In the step S504, the notification unit 209 determines the status information acquisition method as the “vendor protocol”. Note that in this case, the type of the communication interface, which is identified in the step S402, is the WSD, the TCP/IP, or the like. After that, the status information acquisition method determination process is terminated, and the process returns to the status information notification screen-displaying process in FIG. 3.

In the step S505, the notification unit 209 determines whether or not an identifier (ID) necessary for USB connection, which is the information specific to the model of the printing apparatus 102, has been registered in the extension application 204. Note that the ID (identification information) is set by the vendor of the printing apparatus on a printing apparatus-by-printing apparatus basis and is provided to prevent unauthorized communication or use. If it is determined by the notification unit 209 that the ID of the printing apparatus 102 has been registered in the extension application 204, the process proceeds to a step S506. On the other hand, if it is determined by the notification unit 209 that the ID of the printing apparatus 102 has not been registered in the extension application 204, the process proceeds to a step S507.

In the step S506, the notification unit 209 determines the status information acquisition method as the “vendor protocol”. After that, the status information acquisition method determination process is terminated, and the process returns to the status information notification screen-displaying process in FIG. 3. In the step S507, the notification unit 209 determines the status information acquisition method as the “IPP (vendor protocol cannot be used)”. That is, in a case where the type of the communication interface, which is identified in the step S402, is the USB, if the ID of the printing apparatus 102 has not been registered in the extension application 204, the extension application 204 cannot use the vendor protocol for the printing apparatus 102. After that, the status information acquisition method determination process is terminated, and the process returns to the status information notification screen-displaying process in FIG. 3.

FIG. 6 is a flowchart of the status information-complementing process performed by the notification unit 209 in the step S304. In FIG. 6, the status information-complementing process performed in a situation where a paper jam error has occurred in the printing apparatus 102 will be described by way of example, but an error to which the present status information-complementing process is applied is not limited to the paper jam error. For example, in a case where a no-sheet error has occurred in a printing apparatus of a model having a plurality of sheet feeding ports, the status information is complemented by the same process. That is, in the status information-complementing process in FIG. 6, the status information indicating a state of the print processing, and so forth, performed by the printing apparatus 102 connected to the host computer 101, is complemented.

In the status information-complementing process in FIG. 6, first, in a step S601, the notification unit 209 determines whether or not the status information acquisition method determined in the step S302 is the IPP. If it is determined by the notification unit 209 that the status information acquisition method determined in the step S302 is not the IPP, the detailed status information has already been acquired by communication using the vendor protocol. Therefore, in this case, the status information-complementing process is terminated, and the process returns to the status information notification screen-displaying process in FIG. 3. On the other hand, if it is determined by the notification unit 209 that the status information acquisition method determined in the step S302 is the IPP, the process proceeds to a step S602. In this case, the communication unit 209 cannot perform communication using the vendor protocol, and hence the notification unit 209 acquires the detailed status information by performing the status information-complementing process in the step S304, as described hereinafter.

In the step S602, the notification unit 209 determines whether or not a paper-jam error has occurred in the printing apparatus 102. This determination is performed based on the status information already acquired by communication using the IPP in the step S303. If it is determined by the notification unit 209 that a paper-jam error has not occurred in the printing apparatus 102, the status information-complementing process is terminated, and the process returns to the status information notification screen-displaying process in FIG. 3. Note that in this case, only the status information already acquired by communication using the IPP in the step S303 is displayed on the display section 119. On the other hand, if it is determined by the notification unit 209 that a paper-jam error has occurred in the printing apparatus 102, the process proceeds to a step S603.

In the step S603, the notification unit 209 acquires a list of candidates of a method of recovering from an error in a case where a paper-jam error occurs, which are held by the extension application 204. Specifically, there is a case where the vendor desires to guide the methods for removing a jammed sheet to a user, in a state subdividing the methods according to easiness of removing a jammed sheet, i.e. according to a case where a sheet is jammed around a sheet feeding port or a sheet discharging port of the printing apparatus, a case where a sheet is jammed at a location where the jammed sheet cannot be removed without removing a component of the printing apparatus, and the like. For this reason, the extension application 204 holds the list of candidates of the method of recovering from an error in a case where a paper-jam error occurs, inside thereof. Note that this information can be stored inside the extension application 204 as information on each model, or can be stored as model independent information with respect to all sheet feeding ports and dynamically determined based on the sheet feeding port information acquired by communication using the IPP.

In a step S604, the notification unit 209 displays the error recovery method candidate list (candidate list) acquired in the step S603 on the display section 119 in a form selectable by the user. Note that, originally, it is desirable to uniquely display a detailed error recovery method to be guided, according to the status information acquired from the printing apparatus 102. However, it is sometimes impossible to display a detailed error recovery method by the IPP communication, and hence necessary information is complemented by displaying the error recovery method candidate list to the user as described above and prompting the user to select an error recovery method.

In a step S605, the notification unit 209 receives a user's selection operation for the error recovery method candidate list displayed on the display section 119 in the step S604. Note that the user performs an operation for selecting a method which is most suitable for the error situation and makes it possible to most easily recover from the error, from the error recovery method candidate list displayed on the display section 119 in the step S604 by using the pointing device 117 or the like. In this step, when one error recovery method is selected by the user from the error recovery method candidate list displayed on the display section 119, the process proceeds to a step S606. In the step S606, the notification unit 209 determines a detailed guidance to be displayed on the display section 119, which corresponds to the selected error recovery method, from the information stored inside the extension application 204. With this determination, the notification unit 209 acquires the information which cannot be acquired by communication using the IPP. After that, the status information-complementing process is terminated, and the process returns to the status information notification screen-displaying process in FIG. 3.

FIG. 7 is a diagram showing an example of a detailed guidance which can be displayed on the display section 119 by the notification unit 209, which is an example of the status information notification screen 701 displayed in a case where the communication protocol is the vendor protocol. Note that in the case shown in FIG. 7, the detailed status information is acquired by communication using the vendor protocol uniquely specified by the vendor of the printing apparatus 102, and hence the status complementing information in the step S304 is not acquired. The status information notification screen 701 is formed by a status message 702, a browser start button 703, a print stop button 704, a remaining amount display 705, an ink icon 706, and a browser start button 707. When the browser start button 703 is operated by the user using the pointing device 117 or the like, a Web manual is displayed on the display section 119.

When the print stop button 704 is operated by the user using the pointing device 117 or the like, a cancel instruction is given for a job being printed. When the browser start button 707 is operated by the user using the pointing device 117 or the like, a site for purchasing ink which is a consumable is displayed on the display section 119. The remaining amount display 705 is a display indicating a remaining amount of ink mounted in the printing apparatus 102. The ink icon 706 is a warning display displayed in a case where the remaining amount of ink becomes small. In a case where communication using the vendor protocol is performed, the status information notification screen 701 shown in FIG. 7 can guide a detailed method of coping with the error having occurred to the user by displaying the status message 702. At the same time, the status information notification screen 701 can guide the user to the Web manual by displaying the browser start button 703.

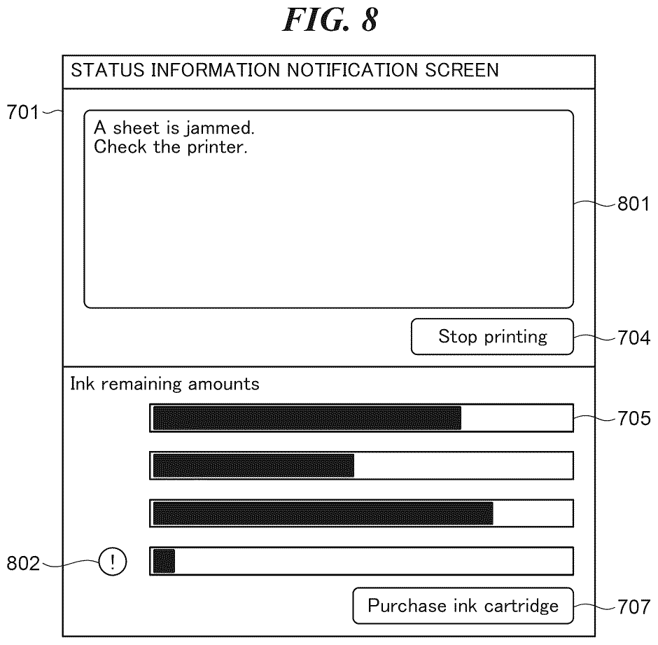

FIG. 8 is a diagram showing an example of a guidance which can be displayed on the display section 119 by the notification unit 209, which is an example of the status information notification screen 701 displayed in a case where the communication protocol is the IPP and the status information-complementing process in the step S304 is not performed. Note that the status information notification screen 701 shown in FIG. 8 is not an example of the screen displayed by executing the status information notification screen-displaying process in FIG. 3, but an example of the screen realized by the conventional technique (i.e. comparative example). Reference numeral 801 denotes a status message. Reference numeral 802 denotes an ink icon as a warning display displayed in a case where the remaining amount of ink becomes small.

In a case where communication using the IPP is performed, only general status information referred to as the media-jam-error, which expresses a paper jam, is acquired, and hence the status information notification screen 701 shown in FIG. 8 can provide only a simple guidance, such as the status message 801. Further, although the browser start button 703 appearing in FIG. 7 is for a function of guiding a detailed error recovery method to the user based on the Web manual by transmitting the status information to the Web manual site, but the browser start button 703 is not included in the status information notification screen 701 shown in FIG. 8. This is because the detailed status information cannot be transmitted in a case where communication using the IPP is performed, and hence the Web manual site is not available. Note that the components which are not particularly mentioned in the above description are the same as those appearing in FIG. 7.

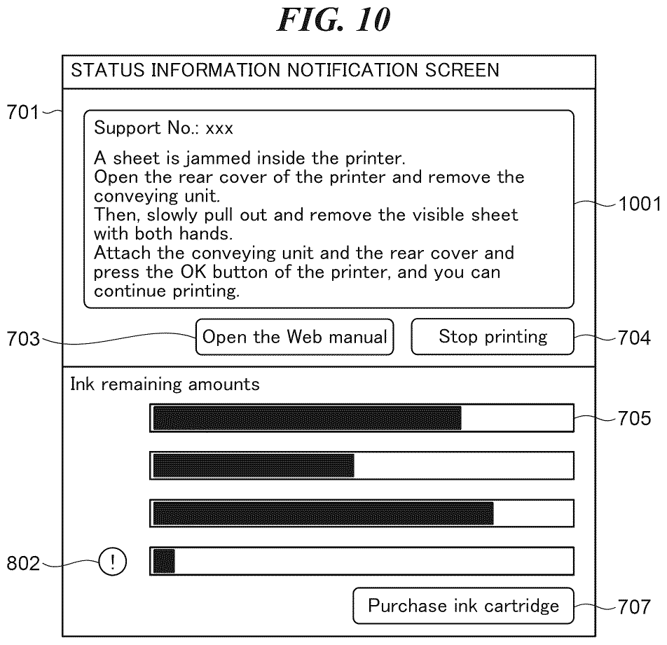

FIG. 9 is a diagram showing an example of display, which is displayed when the notification unit 209 displays the list of candidates of an error recovery method for recovering from a paper jam error on the display section 119, in the status information-complementing process in the step S304. Specifically, the candidate list screen 901 shown in FIG. 9 is a screen displayed in the step S604. The candidate list screen 901 shown in FIG. 9 is formed by a message group 902, a list 903, and a selection completion button 904. The message group 902 describes a simple status message and a message for prompting a user to select a position where the sheet is visible. In the list 903, the error recovery method candidate list acquired in the step S603 is displayed. The user selects one error recovery method from the error recovery method candidate list shown in the list 903, by using a radio button. The selection completion button 904 is a button for expressing that user selection is terminated. When the selection completion button 904 is operated by the user using the pointing device 117 or the like, for example, details of the error recovery method selected from the list 903 are displayed on the display section 119, as on the status information notification screen 701 described hereinafter with reference to FIG. 10.

FIG. 10 is a diagram showing an example of a detailed guidance which can be displayed on the display section 119 by the notification unit 209, which is an example of the status information notification screen 701 displayed in a case where the communication protocol is the IPP and the status information- complementing process in the step S304 is performed. On the status information notification screen 701 shown in FIG. 10, by executing the status information-complementing process in the step S304 according to the flowchart in FIG. 6, a status message 1001 is displayed. By displaying the status message 1001, the status information notification screen 701 shown in FIG. 10 can provide to the users, a detailed guidance equivalent to the status message 702 displayed in a case where the communication protocol is the vendor protocol. Further, on the status information notification screen 701 shown in FIG. 10, by executing the status information-complementing process in the step S304 according to the flowchart in FIG. 6, the above-mentioned browser start button 703 is displayed. Therefore, the status information notification screen 701 shown in FIG. 10 can guide the user to the Web manual by using the browser start button 703. Note that the components which are not particularly mentioned in the above description are the same as those appearing in FIGS. 7 and 8.

As described above, in the first embodiment, in the host computer 101, the extension application 204 is associated with the standard driver 202 which can perform communication with any printing apparatuses of different models by using the IPP. Further, even in a case where communication with the printing apparatus 102 connected to the host computer 101 is performed by using the IPP, the extension application 204 displays the state of the printing apparatus 102 in detail equivalent to a case where communication with the printing apparatus 102 is performed by using the vendor protocol.

Specifically, the extension application 204 displays the error recovery method candidate list based on the status information of the printing apparatus 102, which is acquired by communication using the IPP, and receives a user's selection operation performed with respect to the error recovery method candidate list. With this, even in a case where communication with the printing apparatus 102 is performed by using the IPP, the extension application 204 can provide a detailed status notification as displayed on the status information notification screen 701 shown in FIG. 10 by acquiring new information by using a method different from communication using the IPP. That is, even in a case where communication using the vendor protocol uniquely defined by the vendor of the printing apparatus 102 is not available, the extension application 204 can provide a detailed status notification by using a user's selection operation performed with respect to the error recovery method candidate list.

Further, in the first embodiment, the extension application 204 switches the communication protocol used in communication with the printing apparatus 102 to the vendor protocol or the IPP according to a type of the standard driver 202 and a type of the communication interface. Further, in a case where the communication protocol used in communication with the printing apparatus 102 is the vendor protocol, the extension application 204 provides a detailed guidance to the user based on the status information of the printing apparatus 102, which is acquired by communication using the vendor protocol. On the other hand, in a case where the communication protocol used in communication with the printing apparatus 102 is the IPP, the extension application 204 provides a detailed guidance to the user, by receiving a user's input and complementing the information. Thus, the extension application 204 can provide a detailed status notification to the user to a possible extent regardless of a type of the standard driver 202 and a type of the communication interface.

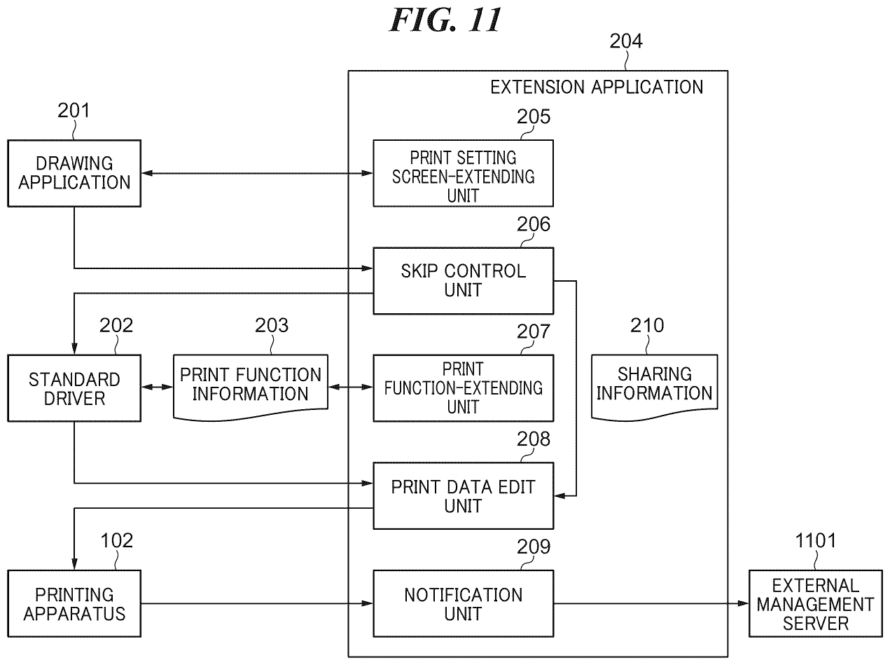

A second embodiment and a third embodiment will be described below with reference to FIGS. 11 to 18. In the description of the second embodiment, the description will be given mainly of differences from the first embodiment. In the first embodiment, the extension application 204 is required to store necessary information inside thereof. That is, in the first embodiment, the extension application 204 is required to store all information specific to a printing apparatus of which the operation is guaranteed. Therefore, in the first embodiment, it is indispensable to regularly release the extension application 204 on the market in expectation of a case of an increase in the number of target models of the extension application 204 and a case of necessity of correction of the information held by the extension application 204. By taking this point into consideration, in the second embodiment, the necessary information is stored in the outside, such as a server. Further, the extension application 204 is enabled to provide a detailed guidance to the user, similar to the first embodiment, by referring to the information stored in the outside, as required e.g. in a case where an error occurs in the printing apparatus 102. Not that the components and the process which are not described in the following description are the same as those in the first embodiment, and hence description thereof is omitted.

FIG. 11 is a block diagram useful in explaining a software configuration of the printing system in the second and third embodiments. In the printing system in the second and third embodiments, the extension application 204 is associated with the standard driver 202 and the printing apparatus 102. Further, the notification unit 209 acquires necessary information from a database of an external management server 1101 (server) storing service information associated with the printing apparatus 102 and the information specific to the printing apparatus 102. Note that the components appearing in FIG. 11 which are other than the above-described components are the same as those of the first embodiment, which appear in FIG. 2B, and hence description of these is omitted.

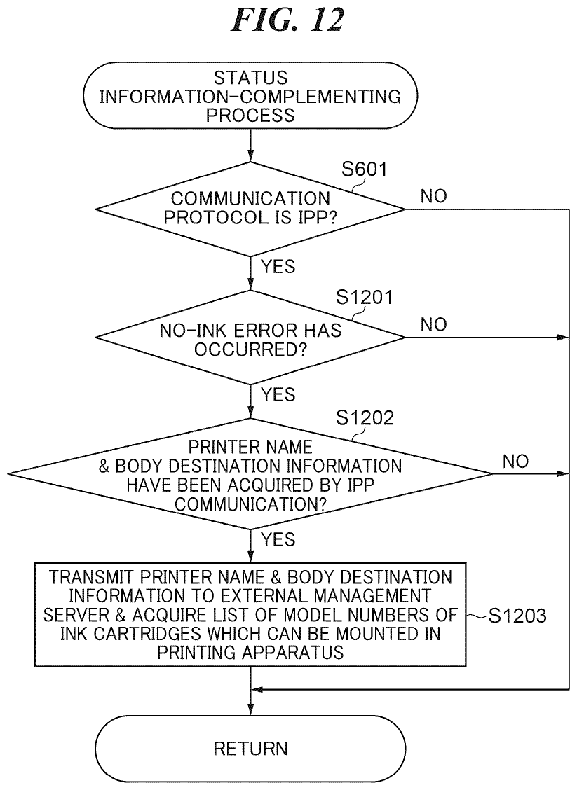

FIG. 12 is a flowchart of a status information-complementing process (step S394) performed by the notification unit 209 in the second embodiment. In FIG. 12, although the status information-complementing process in a situation where a no-ink error has occurred in the printing apparatus 102 will be described by way of example, an error to which this status information-complementing process is applied is not limited to the no-ink error. For example, the status information indicating whether or not firmware newer than the firmware being used exists and is available, which is determined based on a printer name of the printing apparatus 102 and a version of the firmware used by the printing apparatus 102, is complemented by the same process. That is, in the status information-complementing process in FIG. 12, the status information indicating a state of the printing apparatus 102 connected to the host computer 101, a state of print processing executed by the printing apparatus 102, a state of consumables (ink cartridges) mounted in the printing apparatus 102, and so forth is complemented.

In the status information-complementing process in FIG. 12, the step S601 to be executed first is the same processing as that in the first embodiment, and hence description thereof is omitted. Note that if it is determined by the notification unit 209 in the step S601 in FIG. 12 that the status information acquisition method determined in the step S302 is the IPP, the process proceeds to a step S1201. In the step S1201, the notification unit 209 determines whether or not a no-ink error has occurred in the printing apparatus 102. This determination is performed based on the status information which has already been acquired by communication using the IPP in the step S303. If it is determined by the notification unit 209 that a no-ink error has not occurred in the printing apparatus 102, the status information-complementing process is terminated, and the process returns to the status information notification screen-displaying process in FIG. 3. Note that in this case, only the status information which has already been acquired by communication using the IPP in the step S303 is displayed on the display section 119. On the other hand, if it is determined by the notification unit 209 that a no-ink error has occurred in the printing apparatus 102, the process proceeds to a step S1202.

In the step S1202, the notification unit 209 determines whether or not the printer name of the printing apparatus 102 and destination information associated with the body of the printing apparatus 102 (hereinafter referred to as the “body destination information”) have been acquired in acquisition of the status information using the IPP in the step S303. If it is determined by the notification unit 209 that the printer name of the printing apparatus 102 and the body destination information have not been acquired in acquisition of the status information using the IPP in the step S303, the status information-complementing process is terminated. After that, the process returns to the status information notification screen-displaying process in FIG. 3. Note that in this case, only the status information which has already been acquired by communication using the IPP in the step S303 is displayed on the display section 119. On the other hand, if it is determined by the notification unit 209 that the printer name of the printing apparatus 102 and the body destination information have been acquired in acquisition of the status information using the IPP in the step S303, the process proceeds to a step S1203.

In the step S1203, the notification unit 209 transmits the printer name of the printing apparatus 102 and the body destination information, which have already been acquired in the step S303, to the external management server 1101 and acquires a list of model numbers of ink cartridges which can be mounted in the printing apparatus 102, as a response to the transmitted information. Thus, the notification unit 209 acquires the information which cannot be acquired by communication using the IPP. After that, the status information-complementing process is terminated, and the process returns to the status information notification screen-displaying process in FIG. 3.

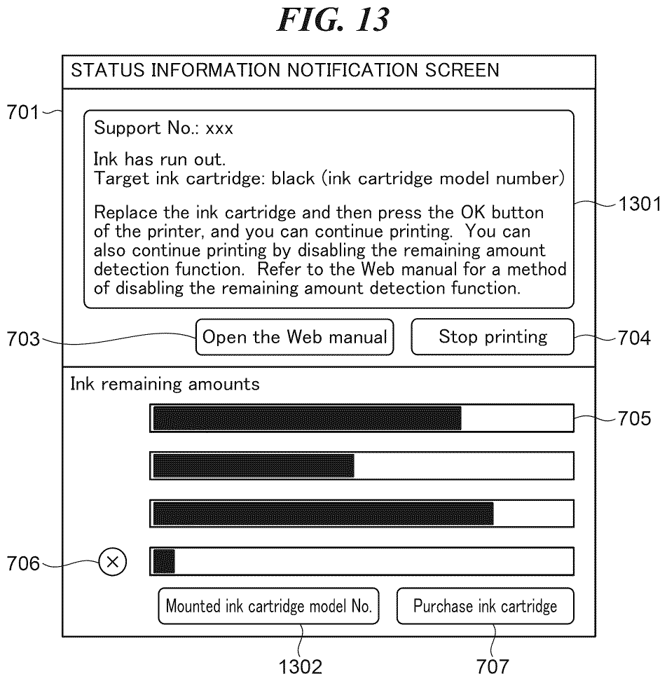

FIG. 13 is a diagram showing an example of a detailed guidance which can be displayed on the display section 119 by the notification unit 209, which is an example of the status information notification screen 701 displayed in a case where the communication protocol is the vendor protocol. Note that in the case shown in FIG. 13, the detailed status information is acquired by communication using the vendor protocol uniquely specified by the vendor of the printing apparatus 102, and hence the status complementing information in the step S304 is not acquired. The status information notification screen 701 shown in FIG. 13 can provide a detailed guidance associated with the no-ink error by using a status message 1301. Further, on the status information notification screen 701 shown in FIG. 13, a mounted ink cartridge model number display button 1302 is displayed. When the mounted ink cartridge model number display button 1302 is operated by the user using the pointing device 117 or the like, another screen showing a list of the model numbers of ink cartridges mounted in the printing apparatus 102 is displayed on the display section 119. However, the notification unit 209 can display the model numbers on the status information notification screen 701 shown in FIG. 13 without displaying the mounted ink cartridge model number display button 1302. Note that the components which are not particularly mentioned in the above description are the same as those appearing in FIG. 7.

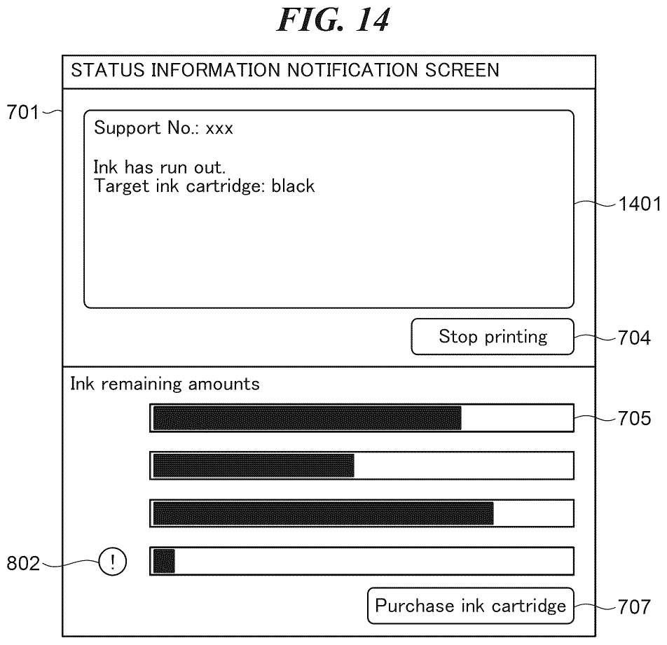

FIG. 14 is a diagram showing an example of a guidance which can be displayed on the display section 119 by the notification unit 209, which is an example of the status information notification screen 701 displayed in a case where the communication protocol is the IPP and the status information-complementing process in the step S304 is not performed. Note that the status information notification screen 701 shown in FIG. 14 is not an example of the screen displayed by executing the status information notification screen-displaying process in FIG. 3, but an example of the screen realized by the conventional technique (i.e. comparative example). In a case where communication using the IPP is performed, only the general status information based on the IPP standard can be acquired, and hence the status information notification screen 701 shown in FIG. 14 can provide only such a simple guidance as indicated by a status message 1401. Further, the status information notification screen 701 shown in FIG. 14 cannot display the mounted ink cartridge model number display button 1302 appearing in FIG. 13 for the same reason. Note that the components which are not particularly mentioned in the above description are the same as those appearing in FIGS. 7 and 8.

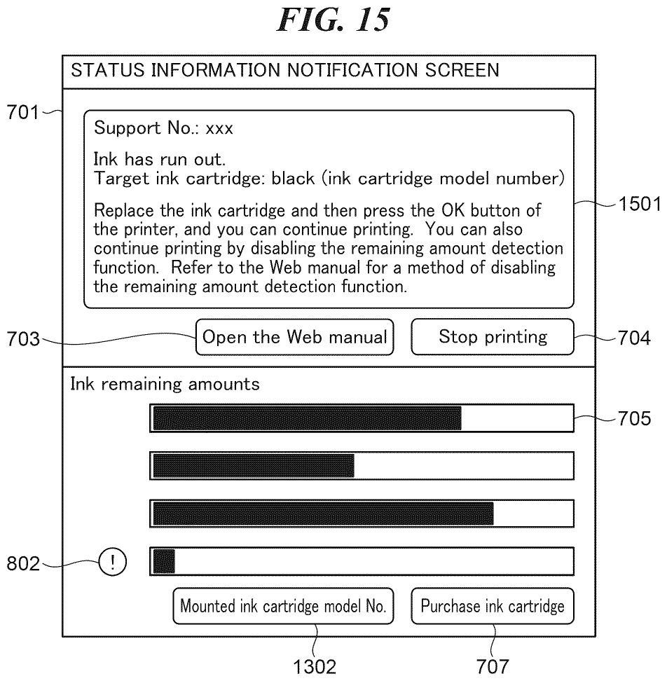

FIG. 15 is a diagram showing an example of a detailed guidance which can be displayed on the display section 119 by the notification unit 209, which is an example of the status information notification screen 701 displayed in a case where the communication protocol is the IPP and the status information-complementing process in the step S304 is performed. On the status information notification screen 701 shown in FIG. 15, by executing the status information-complementing process in the step S304 according to the flowchart in FIG. 12, a status message 1501 is displayed which includes an ink cartridge model number of an ink cartridge as to which the no-ink error having occurred is detected The status information notification screen 701 shown in FIG. 15 can provide a detailed guidance by using the status message 1501 equivalent to the status message 1301 displayed in the case where the communication protocol is the vendor protocol.

Further, on the status information notification screen 701 shown in FIG. 15, the above-mentioned mounted ink cartridge model number display button 1302 is displayed by executing the status information-complementing process in the step S304 according to the flowchart in FIG. 12. Therefore, on the status information notification screen 701 shown in FIG. 15, another screen showing a list of the model numbers of ink cartridges mounted in the printing apparatus 10 is displayed on the display section 119 by using the mounted ink cartridge model number display button 1302. Note that the components which are not particularly mentioned in the above description are the same as those appearing in FIGS. 7 and 8.

As described above, in the second embodiment, similar to the first embodiment, in the host computer 101, the extension application 204 is associated with the standard driver 202 which can perform communication with any printing apparatuses of different models by using the IPP. Further, even in a case where communication with the printing apparatus 102 connected to the host computer 101 is performed by using the IPP, the extension application 204 displays the state of the printing apparatus 102 in detail to an extent equivalent to a case where communication with the printing apparatus 102 is performed by using the vendor protocol.

Specifically, the extension application 204 acquires the model number list of ink cartridges which can be mounted in the printing apparatus 102 from the database of the external management server 1101 based on the status information of the printing apparatus 102, which has been acquired by communication using the IPP. With this, even in a case where communication with the printing apparatus 102 is performed by using the IPP, the extension application 204 can perform a detailed status notification as displayed on the status information notification screen 701 shown in FIG. 15 by acquiring new information by using a method different from communication using the IPP.

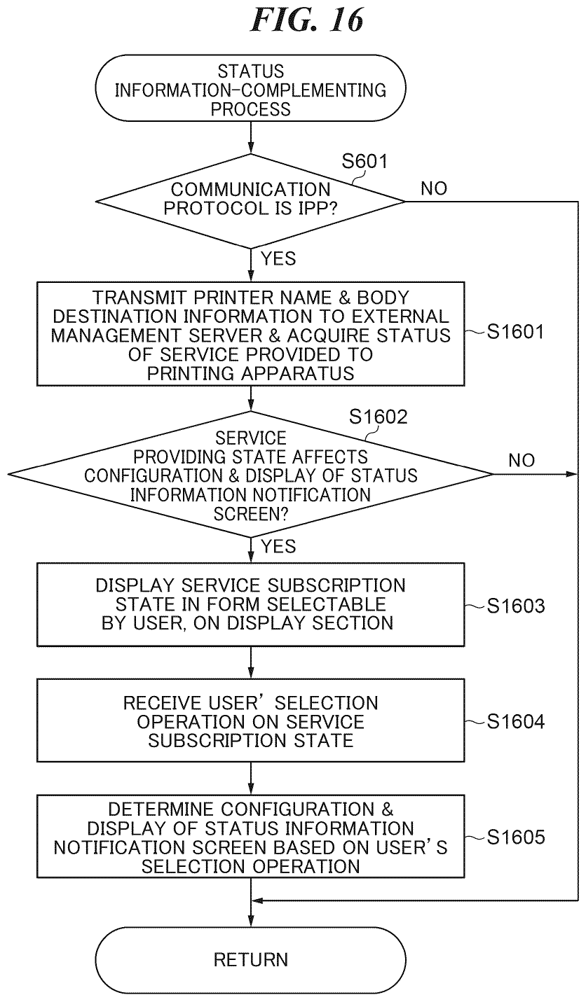

The third embodiment will be described below with reference to FIGS. 16 to 18. In the first embodiment, the extension application 204 holds the necessary information, and in the second embodiment, the external management server 1101 or the like stores the same. Further, these information items are information specific to the printing apparatus 102. Incidentally, when a user actually uses the printing apparatus 102, in some cases, the user sometimes uses a subscription service provided by the vendor of the printing apparatus 102. In this case, not only the information specific to the printing apparatus 102, but information specific to the user is also required to be considered. By taking this point into consideration, in the third embodiment, information, such as what service is provided to the printing apparatus 102, is stored in the external management service 1101 or the like.

Further, when generating a status information notification screen, the extension application 204 refers to the information stored in the external management service 1101 or the like and displays a state of provision of the service to prompt the user to select a service subscription state. With this, in the third embodiment, a proper guidance is provided to the user. Note that the following description will be given mainly of differences from the second embodiment. Therefore, the components and processing operations which are not particularly mentioned in the following description are the same as those in the second embodiment, and hence description thereof is omitted.

FIG. 16 is a flowchart of the status information-complementing process (step S304) performed by the notification unit 209 in the third embodiment. In the status information-complementing process in FIG. 16, the step S601 to be executed first is the same processing as that in the first embodiment, and hence description thereof is omitted. Note that if it is determined by the notification unit 209 in the step S601 in FIG. 16 that the status information acquisition method determined in the step S302 is the IPP, the process proceeds to a step S1601. In the step S1601, the notification unit 209 transmits the printer name of the printing apparatus 102 and the body destination information, which are acquired in the step S303, to the external management server 1101. Further, in the step S1601, the notification unit 209 acquires a situation of a service provided to the printing apparatus 102 by the vendor of the printing apparatus 102 (hereinafter referred to as the “situation of providing the service to the printing apparatus 102”) as a response to the transmitted information. Note that the determination processing in the step S1202 in FIG. 12 can be executed between the step S601 and the step S1601.

In a step S1602, the notification unit 209 determines whether or not the situation of providing the service to the printing apparatus 102, which is acquired in the step S1601, has an undesired influence on the configuration and display of the status information notification screen 701. The determination is performed, for example, based on a table held by the extension application 204, which shows a relationship between the undesired influence on the configuration and display of the status information notification screen 701 and the service, and the situation of providing the service to the printing apparatus 102. Note that a formula of the determination can be stored in the database of the external management server 1101, and the notification unit 209 of the extension application 204 can refer to a result of the determination performed by the external management server 1101.

If it is determined by the notification unit 209 that the situation of providing the service to the printing apparatus 102, which is acquired in the step S1601, has no undesired influence on the configuration and display of the status information notification screen 701, the status information-complementing process is terminated. After that, the process returns to the status information notification screen-displaying process in FIG. 3. Note that in this case, only the status information already acquired by communication using the IPP in the step S303 is displayed on the display section 119. On the other hand, if it is determined by the notification unit 209 that the situation of providing the service to the printing apparatus 102, which is acquired in the step S1601, has an undesired influence on the configuration and display of the status information notification screen 701, the process proceeds to a step S1603.

In the step S1603, the notification unit 209 displays a screen for prompting the user to select the service subscription state from a list of services (candidate list) provided to the printing apparatus 102 on the display section 119. In a step S1604, the notification unit 209 receives a user's selection operation with respect to the service subscription state. In a step S1605, the notification unit 209 determines the configuration and display of the status information notification screen 701 based on the user's selection operation. Thus, the notification unit 209 acquires the information which cannot be acquired by communication using the IPP. After that, the status information-complementing process is terminated, and the process returns to the status information notification screen-displaying process in FIG. 3. In the following description, a case where the vendor of the printing apparatus 102 provides a fixed rate service for ink to the printing apparatus 102, and the user has subscribed to this service will be described. Therefore, in the status information-complementing process in FIG. 16, the status information indicating a state of the printing apparatus 102 connected to the host computer 101 and so forth is complemented.

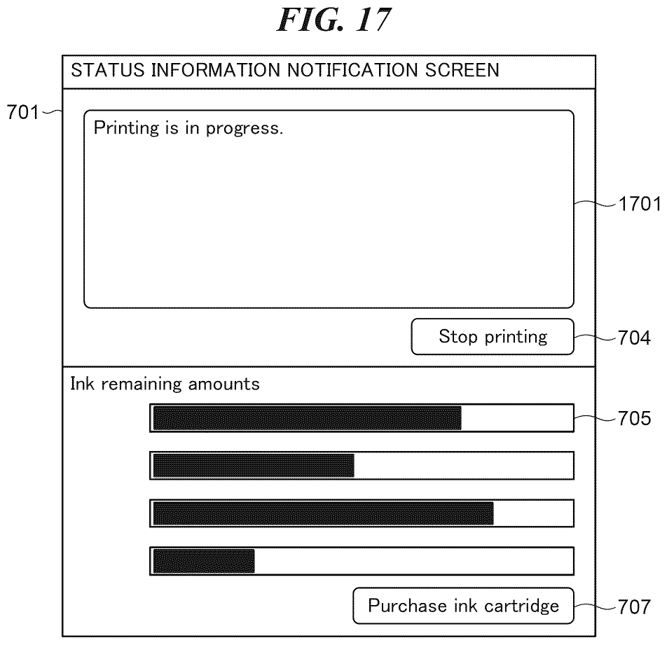

FIG. 17 is a diagram showing an example of a guidance which can be displayed on the display section 119 by the notification unit 209, which is an example of the status information notification screen 701 displayed in a case where the communication protocol is the IPP and the status information-complementing process in the step S304 is not performed. Note that the status information notification screen 701 shown in FIG. 17 is not an example of the screen displayed by executing the status information notification screen-displaying process in FIG. 3, but an example of the screen realized by the conventional technique (i.e. comparative example). If the fixed rate service for ink which is a consumable is provided from the vendor of the printing apparatus 102 to the printing apparatus 102 and the user has subscribed to this service, the browser start button 707 for displaying the ink purchase site should not be displayed. However, on the status information notification screen 701 shown in FIG. 17, the browser start button 707 is displayed. Note that the components which are not particularly mentioned in the above description are the same as those appearing in FIG. 7.

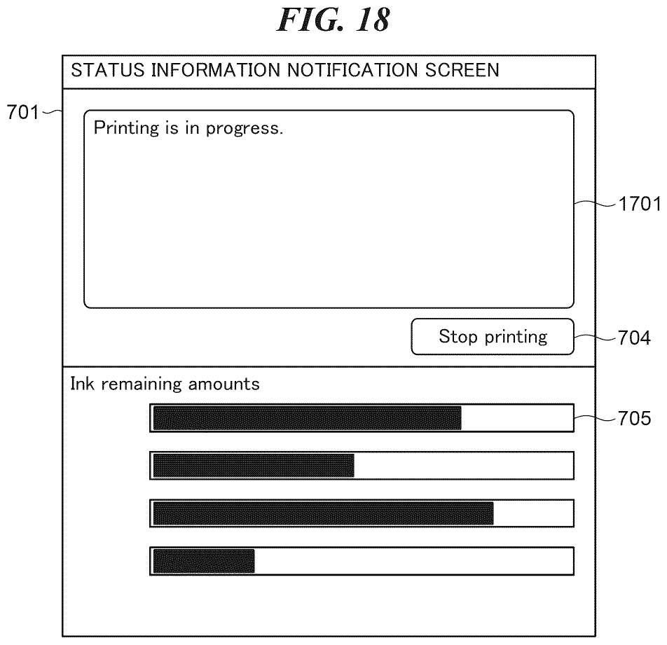

FIG. 18 is a diagram showing an example of a proper guidance which can be displayed on the display section 119 by the notification unit 209, which is an example of the status information notification screen 701 displayed in a case where the communication protocol is the IPP and the status information-complementing process in the step S304 is performed. When the status information-complementing process in the step S304 is executed according to the flowchart in FIG. 16, the above-mentioned browser start button 707 is hidden only on the user who has subscribed to the fixed rate service for ink as displayed by the status information notification screen 701 shown in FIG. 18. Note that the components which are not particularly mentioned in the above description are the same as those appearing in FIG. 7.

As described above, in the third embodiment, similar to the first and second embodiments, in the host computer 101, the extension application 204 is associated with the standard driver 202 which can perform communication with any printing apparatuses of different models by using the IPP. Further, even in a case where communication with the printing apparatus 102 connected to the host computer 101 is performed by using the IPP, the extension application 204 displays the state of the printing apparatus 102 with appropriateness equivalent to a case where communication with the printing apparatus 102 is performed by using the vendor protocol. Specifically, on the status information notification screen 701 shown in FIG. 18, the browser start button 707 for displaying the ink purchase site is properly displayed/hidden in accordance with the subscription state of the user to the ink fixed rate service.

Further, in the third embodiment, the extension application 204 acquires the situation of providing the service to the printing apparatus 102 from the database of the external management server 1101 based on the status information of the printing apparatus 102, which is acquired by communication using the IPP. Further, the extension application 204 displays the list of the services provided to the printing apparatus 102 and receives a user's selection operation with respect to the service subscription state. With this, even when communication with the printing apparatus 102 is performed by using the IPP, the extension application 204 can provide a proper status notification as displayed on the status information notification screen 701 shown in FIG. 18, by acquiring new information by using a different method from communication using the IPP.

Tus, the extension application 204 displays the candidate list with reference to the data managed by the database of the external management server 1101 or the like and makes it possible to provide a proper guidance by prompting the user to select a candidate matching the state of himself/herself. That is, the extension application 204 can provide a proper guidance by determining whether or not the user has subscribed to the service provided to the printing apparatus 102 based on a combination of use of the database of the external management server 1101 and the user's selection operation.

The present invention has been described heretofore based on the embodiments thereof. However, the present invention is not limited to the above-described embodiments, but it can be practiced in various forms, without departing from the spirit and scope thereof. Here, a case where the type of the standard driver 202 is the UP Class Driver, and the printing apparatus 102 can communicate with a cloud service by using a communication protocol corresponding to the vendor protocol will be described. In this case, the host computer 101 and the printing apparatus 102 cannot directly communicate with each other, but the cloud service can acquire the status information of the printing apparatus 102 from the printing apparatus 102 by using the communication protocol corresponding to the vendor protocol. Therefore, the extension application 204 can acquire the status information of the printing apparatus 102 from the cloud service by using a communication protocol different from the IPP. By doing this, the extension application 204 can provide a detailed status notification by acquiring new information by using a method different from communication using the IPP e.g. when an error has occurred in the printing apparatus 102.

Further, the extension application 204 can acquire new information by a combination of the information acquired from the above-mentioned cloud service and the information acquired from the database of the external management server 1101 or the like. Further, the extension application 204 can acquire new information by a combination of the information acquired from the above-described cloud service and a user's selection operation performed with respect to the candidate list related to the acquired information. Further, the extension application 204 can acquire new information by a combination of the information acquired from the above-described cloud service, the information acquired from the database of the external management server 1101 or the like, and a user's selection operation performed with respect to the candidate list related to these information items. Further, in a case where communication using the vendor protocol is not available, the extension application 204 can acquire new information by a combination of a plurality of information items which can be acquired by communication using the IPP.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-180108 filed Oct. 19, 2023, which is hereby incorporated by reference herein in its entirety.

What is claimed is:

1. A method of controlling an information processing apparatus including a standard driver that can communicate with a plurality of printing apparatuses provided by a plurality of vendors, by using a first protocol, and an application that is associated with the standard driver and supports the standard driver, comprising:
acquiring, by the application, first status information of a printing apparatus connected to the information processing apparatus, by using a method different from communication using the first protocol; and
displaying, by the application, a status information notification screen based on the first status information.

2. The method according to claim 1, further comprising acquiring, by the application, second status information of the printing apparatus connected to the information processing apparatus by communication using the first protocol, and
wherein the acquiring includes displaying, by the application, the status information notification screen based on the first status information and the second status information.

3. The method according to claim 1, wherein the first status information is information indicating at least one of a state of the printing apparatus connected to the information processing apparatus, a state of print processing, and a state of consumables mounted in the printing apparatus connected to the information processing apparatus.

4. The method according to claim 1, wherein the first status information is information which cannot be acquired by communication using the first protocol.

5. The method according to claim 1, wherein the acquiring of the first status information includes acquiring, by the application, the first status information by using a database of a server as the method different from communication using the first protocol.

6. The method according to claim 1, wherein the acquiring of the first status information includes acquiring, by the application, the first status information by using a cloud service as a method different from communication using the first protocol.

7. The method according to claim 1, wherein the acquiring of the first status information includes acquiring, by the application, the first status information by using a user's selection operation performed with respect to a candidate list as a method different from communication using the first protocol.

8. The method according to claim 1, wherein the acquiring of the first status information includes acquiring, by the application, the first status information by using a combination of at least two out of a database of a server, a cloud service, and a user's selection operation performed with respect to a candidate list as a method different from communication using the first protocol.

9. The method according to claim 1, wherein the first protocol is the Internet Printing Protocol.

10. The method according to claim 2, wherein the acquiring of the first status information includes acquiring, by the application, the first status information by using a method different from communication using the first protocol in a case where communication using a second protocol different from the first protocol is not available.

11. The method according to claim 10, wherein the acquiring of the second status information includes acquiring, by the application, the second status information by communication using the first protocol in a case where communication using the second protocol is not available.

12. The method according to claim 10, further comprising determining by the application, whether or not communication using the second protocol is available,
wherein the determining includes determining, by the application, that communication using the second protocol is not available in a case where a type of the standard driver is a first printer driver.

13. The method according to claim 12, wherein the determining includes determining, by the application, in a case where a type of the standard driver is a second printer driver different from the first printer driver, and a type of a communication interface with a printing apparatus connected to the information processing apparatus is a predetermined communication interface, that communication using the second protocol is not available when identification information necessary for the predetermined communication interface has not been registered in the application with respect to the printing apparatus connected to the information processing apparatus.

14. The method according to claim 10, wherein the first protocol is the Internet Printing Protocol, and
wherein the second protocol is a vendor protocol uniquely defined by a vendor of the printing apparatus connected to the information processing apparatus.

15. A non-transitory computer-readable storage medium storing a program for causing a computer to execute a method of controlling an information processing apparatus including a standard driver that can communicate with a plurality of printing apparatuses provided by a plurality of vendors, by using a first protocol, and an application that is associated with the standard driver and supports the standard driver,
wherein the method comprises:
acquiring, by the application, first status information of a printing apparatus connected to the information processing apparatus, by using a method different from communication using the first protocol; and
displaying, by the application, a status information notification screen based on the first status information.

16. An information processing apparatus including a standard driver that can communicate with a plurality of printing apparatuses provided by a plurality of vendors, by using a first protocol, and an application that is associated with the standard driver and supports the standard driver, comprising:
a first acquisition unit configured to acquire, by the application, first status information of a printing apparatus connected to the information processing apparatus, by using a method different from communication using the first protocol; and
a display control unit configured to display, by the application, a status information notification screen based on the first status information.
